(19) United States
(12) Patent Application Publication
(10) Pub. No.: US 2017/0366819 A1
(43) Pub. Date: Dec. 21, 2017

(54) Method And Apparatus Of Single Channel Compression

(71) Applicant: MediaTek Inc., Hsinchu City (TW)

(72) Inventors: Tung-Hsing Wu, Chiayi City (TW); Ting-An Lin, Hsinchu City (TW); Han-Liang Chou, Hsinchu County (TW)

(21) Appl. No.: 15/676,668

(22) Filed: Aug. 14, 2017

Related U.S. Application Data
(60) Provisional application No. 62/374,971, filed on Aug. 15, 2016.

(51) Int. Cl. H04N 19/186; H04N 19/124; H04N 19/157; H04N 19/91

(52) U.S. Cl. CPC H04N 19/186; H04N 19/91; H04N 19/124; H04N 19/157

(57) ABSTRACT

A method or apparatus of configuring a multi-channel coding device for use as a single-channel coding device is provided. The multi-channel coding device reconfigured as a single-channel coding device performs encoding or decoding of the pixels for a first color channel while substituting the pixels of a second color channel with predetermined (e.g., fixed) values. The reconfigured coding device may output reconstructed pixels of the first color channel but not reconstructed pixels of the second color channel.

### CROSS REFERENCE TO RELATED PATENT APPLICATION(S)

The present disclosure claims the priority benefit of U.S. Provisional Patent Application No. 62/374,971, filed on 15 Aug. 2016, the content of which is incorporated by reference in its entirety.

### TECHNICAL FIELD

The present disclosure relates generally to video processing. In particular, the present disclosure relates to methods for encoding one or more color channels.

### BACKGROUND

Unless otherwise indicated herein, approaches described in this section are not prior art to the claims listed below and are not admitted as prior art by inclusion in this section.

Modern digital representations of images or video typically have multiple color channels, such as YUV (which has one luminance color channels and two chrominance color channels) or RGB (which has three color channels). In order to encode or decode an image or video with multiple color channels, the encoding or decoding device used has to have corresponding circuits or programming capable of handling encoding or decoding for each of the multiple color channels. The encoding or decoding device also has to have sufficient output bandwidths for delivering reconstructed pixels of the different color channels.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide an image or video encoding system that can be configured to perform single color channel encoding. The single-channel encoding system is an image or video coding electronic apparatus that includes an image or video encoder capable of encoding a multi-channel image having at least first and second color channels. The single-channel encoding system also includes a selection circuit capable of receiving a single-channel mode flag. When the single-channel mode flag indicates a first mode, the selection circuit configures the video encoder to receive first and second sets of pixels and to encode the multi-channel image based on the received first set of pixels for the first color channel and the received second set of pixels for the second color channel. When the single-channel mode flag indicates a second mode, the selection circuit configures the video encoder to receive a first set of pixels and to encode the multi-channel image based on the received first set of pixels for the first color channel and a set of predetermined values for the second color channel.

In some embodiments, when the video encoder is configured to perform single color channel encoding, the single-channel encoding system receives an image having pixels of the first color channel. The single-channel encoding system assigns a set of predetermined values as pixels of the second color channel. The single-channel encoding system encodes the multi-channel image that includes the pixels of the first color channel and the pixels of the second color channel in a bitstream. In some embodiments, the single-channel encoding system encodes the multi-channel image in the bitstream by encoding the pixels of the first color channel into a first set of encoded data and by using a set of predetermined values as a second set of encoded data.

Some embodiments of the disclosure provide an image or video decoding system that can be configured to perform single color channel decoding. The single-channel decoding system is an image or video coding electronic apparatus that includes a video decoder capable of decoding a bitstream having an encoded multi-channel image having at least first and second color channels. The single-channel decoding system also includes a selection circuit capable of identifying a single-channel mode flag based on content of the bitstream. When the single-channel mode flag indicates a first mode, the selection circuit configures the video decoder to decode the multi-channel image to generate pixels of the first and second color channels and to output the decoded pixels of the first and second color channels. When the single-channel mode flag indicates a second mode, the selection circuit configures the video decoder to decode the multi-channel image to generate pixels of the first channel and to output the decoded pixels of the first color channel. The single-channel decoding system does not decode pixels for the second color channel and does not output the decoded pixels of the second color channel.

In some embodiments, the single-channel decoding system receives a bitstream that includes one or more encoded multi-channel images. The bitstream has a first set of encoded data for a first color channel and a second set of encoded data for a second color channel. The single-channel decoding system discards the second set of encoded data. The single-channel decoding system processes the first set of encoded data to obtain the pixels of the first color channel and outputs the pixels of the first color channel as a single channel image. In some embodiments, the single channel decoding system also generates pixels of the second color channel by assigning a set of predetermined values as the pixels of the second color channel (rather than decoding the second set of encoded data).

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIGS. 1 a-b illustrates a single-channel encoding system that is configured to encode pixels of a single color channel into a bitstream.

FIG. 2 illustrates the single-channel encoding system using a single-channel mode flag to determine whether to perform single-channel encoding or multi-channel encoding.

FIGS. 3a-b illustrates the single-channel mode flag being used to determine whether to perform single-channel encoding.

FIGS. 4a-d illustrate predetermined value(s) being used as encoding information for u/v channels at different stages of the video encoder when performing single channel encoding.

FIG. 5 conceptually illustrates processes for encoding pixels from a single channel of an image or a single channel image into a bitstream having an encoded multi-channel image.

FIG. 6 conceptually illustrates a process that uses a single-channel mode flag to configure a video encoder to perform single-channel encoding for a first channel or multi-channel encoding for at least the first channel and a second channel.

FIG. 7 illustrates a video encoder or video encoding apparatus.

FIG. 8 illustrates a single-channel decoding system that is configured to produces a single color channel image (or video) by decoding a bitstream having an encoded multi-channel image.

FIG. 9 conceptually illustrates a process for performing single-channel decoding.

FIG. 10 illustrates the single-channel decoding system being configured to perform single-channel decoding based on a flag embedded in the bitstream.

FIG. 11 illustrates the single-channel decoding system being configured to perform single-channel decoding based on detection of a particular data pattern.

FIG. 12 conceptually illustrates a process that uses a single-channel mode flag to configure the image decoding circuit to perform single-channel decoding or multi-channel decoding.

FIG. 13 illustrates a video decoder or a video decoding apparatus that implements the single-channel decoding system.

FIG. 14 conceptually illustrates an electronic system in which some embodiments of the present disclosure may be implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

Some embodiments of the disclosure provide a method of configuring a multi-channel coding device for use as a single-channel coding device. The multi-channel coding device reconfigured as a single-channel coding device performs encoding or decoding of the pixels for a first color channel while substituting the pixels of a second color channel with predetermined (e.g., fixed) values. The reconfigured coding device may output reconstructed pixels of the first color channel but not reconstructed pixels of the second color channel.

### Single Channel Encoder

Some embodiments of the disclosure provide an image or video encoding system that can be configured to perform single color channel encoding. The single-channel encoding system is an image or video coding electronic apparatus that includes an image or video encoder capable of encoding a multi-channel image having at least first and second color channels. The single-channel encoding system also includes a selection circuit capable of receiving a single-channel mode flag. When the single-channel mode flag indicates a first mode, the selection circuit configures the video encoder to receive first and second sets of pixels and to encode the multi-channel image based on the received first set of pixels for the first color channel and the received second set of pixels for the second color channel. When the single-channel mode flag indicates a second mode, the selection circuit configures the video encoder to receive a first set of pixels and to encode the multi-channel image based on the received first set of pixels for the first color channel and a set of predetermined values for the second color channel.

In some embodiments, when the video encoder is configured to perform single color channel encoding, the single-channel encoding system receives an image having pixels of the first color channel. The single-channel encoding system assigns a set of predetermined values as pixels of the second color channel. The single-channel encoding system encodes the multi-channel image that includes the pixels of the first color channel and the pixels of the second color channel in a bitstream. In some embodiments, the single-channel encoding system encodes the multi-channel image in the bitstream by encoding the pixels of the first color channel into a first set of encoded data and by using a set of predetermined values as a second set of encoded data.

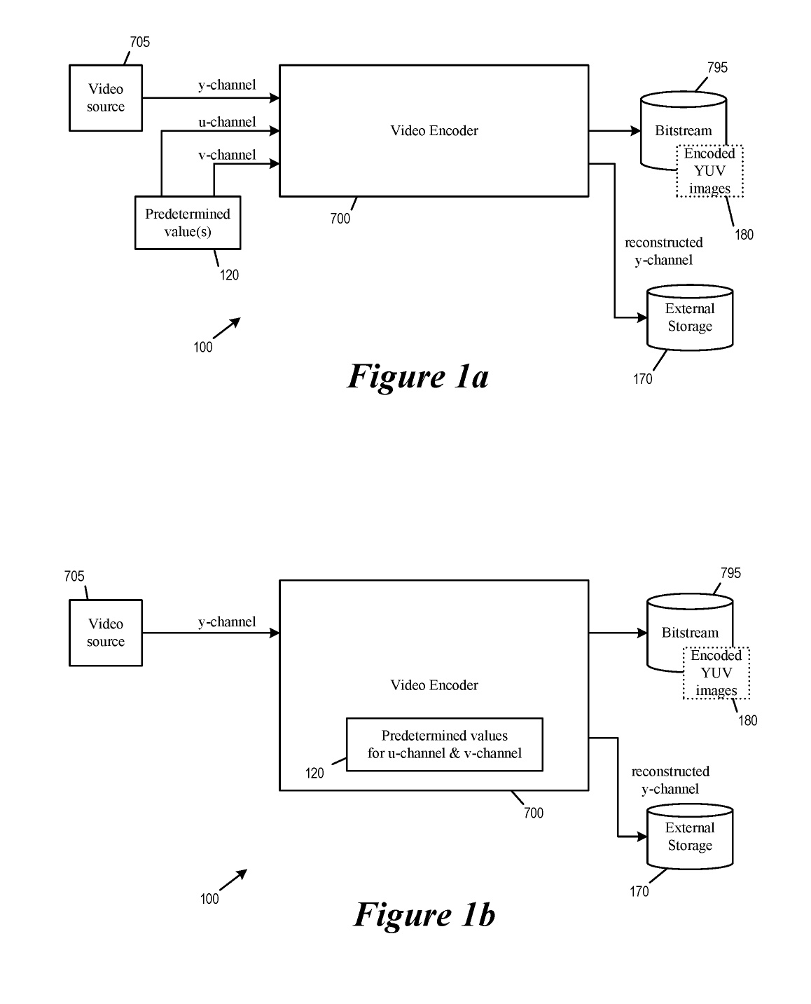

FIGS. 1a-b illustrates a single-channel encoding system 100 that is configured to encode pixels of a single color channel into a bitstream. The single-channel encoding system 100 receives pixels of a single color channel (y-channel) from a video source 705. The single-channel encoding system 100 also receives predetermined value(s) 120 as pixels of one or more other color channels (u-channel and v-channel). The single-channel encoding system 100 then performs video-encoding techniques (including compression) to produce a bitstream 795 that includes encoded images with multiple color channels. The pixels of the y, u, and v color channels may be stored in the bitstream according to formats such as 4:4:4, 4:2:2, or 4:2:0. The encoding operations may also reconstruct pixels from the compressed image. The single-channel encoding system 100 may optionally output the reconstructed y-channel pixels to an external destination (e.g., an external memory 170 or a display device).

The video source 705 provides an array or a series of pixels of one single color channel to the single-channel encoding system 100. The video source 705 may be a video source that provides a sequence of images as pictures or frames of a video sequence. The video source 705 may also be an image source that provides one single still image. The image or images provided by the video source 705 can be single color channel images having pixels in one color channel and no other channel. For example, the video source 705 may provide images having y-channel pixels but not u-channel pixels or v-channel pixels. The image or images provided by the video source 705 may also include multi-color channel images, e.g., images having pixels in y-channel, u-channel, and v-channel. However, the single-channel encoding system 100 receives and encodes only one color channel and not other color channels from the video source 705.

The predetermined value(s) 120 provide values or data that are defined independently of the image information in the video source 705. The predetermined value(s) 120 may provide a single fixed value that does not change. The predetermined value(s) 120 may also provide a fixed sequence of values, such as pixel values from a predetermined, predefined image (e.g. white noise). The predetermine value(s) may also be randomly generated values.

The predetermined value(s) 120 may be provided by circuit or storage that is external to the single-channel encoding system 100. FIG. 1a conceptually illustrates an example single-channel encoding system 100 in which the predetermined value(s) are provided by a source external to the single-channel encoding system 100.

The predetermined value(s) 120 may also be provided internally by the single-channel encoding system 100 itself. In other words, the predetermined value(s) are not received from sources external to the single-channel encoding system 100 (external memory, external storage, etc.) For example, the predetermined value(s) 120 may be defined by hardwired logic or programming of the single-channel encoding system 100. FIG. 1b conceptually illustrates an example single-channel encoding system 100 in which the predetermined values(s) are provided internally by the single-channel encoding system 100 itself.

The single-channel encoding system 100 includes an image or video encoder 700. The video encoder 700 is an image-encoding or video-encoding circuit that performs image and/or video encoding operations that transforms pixel values into encoded compressed images in a bitstream. The bitstream produced by the video encoder 700 may conform to any image-coding or video-coding standard, such as JPEG, MPEG, HEVC, VP9, etc.

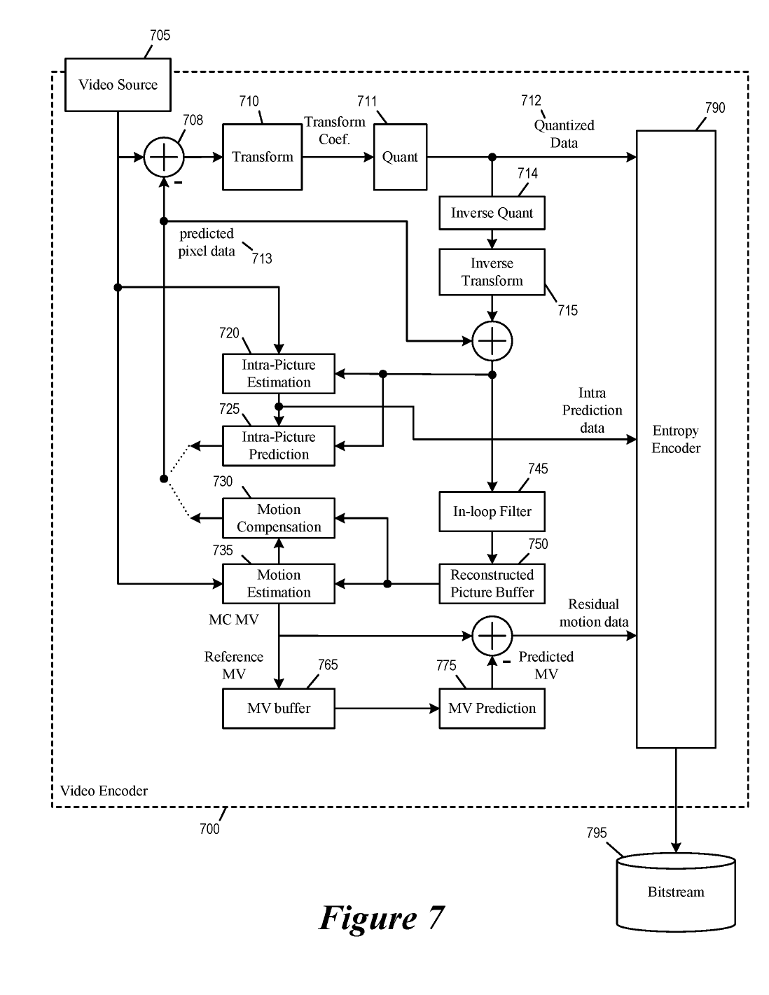

The video encoder 700 provides several modules that are configured to performing various stages of the image/video encoding operations, modules such as a transform module 710, a quantization module 711, an entropy encoding module 790, and various prediction modules (e.g., intra prediction 720 and motion compensation 730). In some embodiments, each color channel has its own set of transform and quantizer modules (e.g., separate hardware circuits or separate software modules). In some embodiments, the different color channels reuse the same transform and quantizer modules. FIG. 7 below provides detailed descriptions of various modules inside the video encoder 700.

In some embodiments, the single-channel encoding system 100 uses a single-channel mode flag to determine whether to perform single-channel encoding or multi-channel encoding. When the single-channel mode flag indicates single-channel mode, the single-channel encoding system 100 encodes only pixels for the y-channel but not the pixels of the u-channel and of the v-channel. When the single-channel mode flag indicates multi-channel mode, the single-channel encoding system 100 behaves like a conventional encoder and encodes all color channels (y, u, and v).

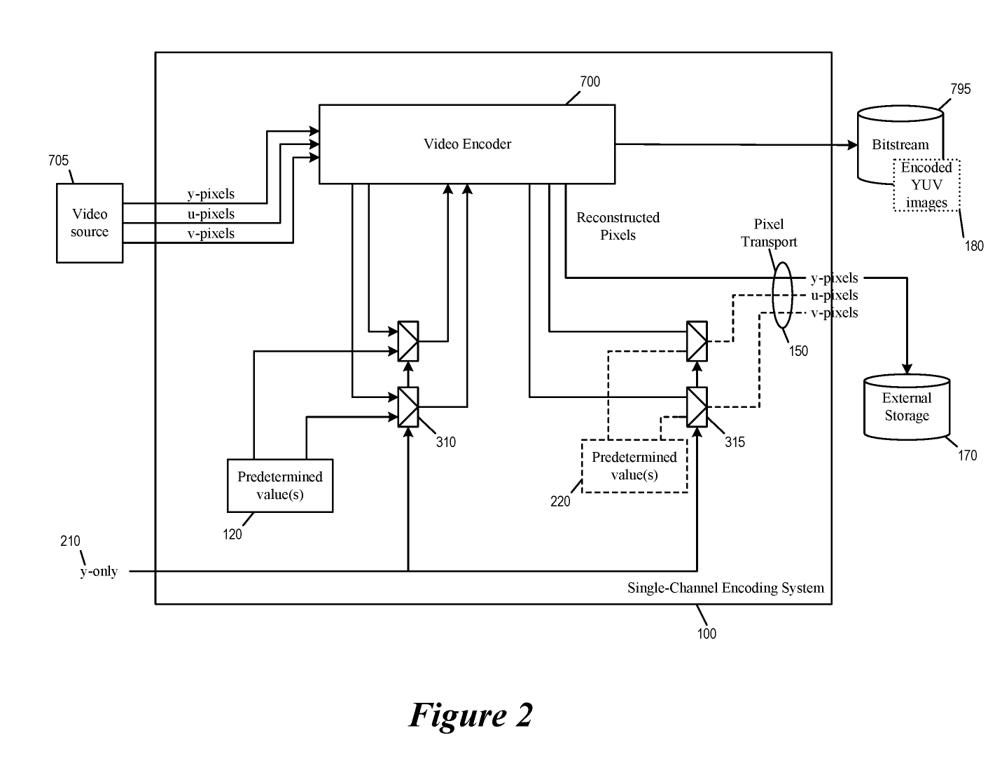

FIG. 2 illustrates the single-channel encoding system 100 using a single-channel mode flag to determine whether to perform single-channel encoding or multi-channel encoding. The single-channel encoding system 100 may receive the single-channel mode flag from another program, or as a discrete control signal from another circuit or device. The video encoder 700 produces the bitstream 795 with compressed/encoded images. The video encoder 700 also optionally produces reconstructed pixels for different color channels. The single-channel encoding system 100 has a pixel transport 150 for outputting the reconstructed pixels of the different channels (e.g., to a display or to an external memory 170). In some embodiments, the pixel transport 150 recognizes redundancy (such as repeat) in the pixel values being outputted and performs compression to remove some of the redundancy. In some embodiments, the pixel transport 150 does not transport any pixel values for the u and v channels. In some embodiments, the external storage 170 is initialized with fixed values for u-channel and v-channel pixels, and the pixel transport 150 does not transport any pixel values for the u and v channels.

As illustrated, the single-channel encoding system 100 receives a single-channel mode flag 210 (“y-only”). The single-channel mode flag determines whether the encoding stages of the video encoder 700 receives and encodes pixels from all channels (y, u, and v channels) of the video source 705, or receive and encode only pixels from one channel (y-channel only).

When the single-channel mode flag is not asserted, the single-channel encoding system 100 behaves like a conventional encoder and the video encoder 700 encodes all color channels (y, u, and v) from the video source 705. When the single-channel mode flag is asserted, the video encoder 700 encodes only y-channel pixels from the video source 120 and use predetermined value(s) 120 to generate information for u and v channels. The predetermined value(s) may be used as pixel values or as intermediate encoded data for stages within the video encoder 700.

The single-channel mode flag is also used to determine how should the single-channel encoding system 100 output reconstructed pixels. As part of the encoding operation, the video encoder 700 produces reconstructed pixels of the image.

When the single-channel mode flag (“y-only”) is not asserted (multi-channel mode), the single-channel encoding system 100 outputs the reconstructed pixels for all color channels. When the single-channel mode flag is asserted (single-channel mode), the single-channel encoding system output reconstructed pixels only for y-channel but not u and v channels. In some embodiments, the single-channel encoding system 100 does not output any pixel for u and v channels through the pixel transport 150. In some embodiments, the single-channel encoding system 100 outputs predetermined value(s) 220 for u and v channels through the pixel transport. (A selection circuit including a multiplexer 315 that selects between the output of the video encoder 700 and the predetermined values 220). The predetermined value(s) sent over the pixel transport 150 are easily compressible so the u and v channel pixels would use up minimum bandwidth at the pixel transport 150.

When configured to perform single channel encoding, the single-channel encoding system 100 may use predetermined value(s) 120 directly as pixel values for other color channels. In some embodiments, the single-channel encoding system 100 uses the predetermined value(s) to replace the output of one of the encoding stages in the video encoder 700 (e.g., transform module 710, quantizer 711, or entropy encoder 790) or as input to be injected into one of the encoding stages. In other words, the predetermined value(s) may be used as residual pixel data (e.g., input of transform module 710), transform coefficients (e.g., input of quantizer 711), quantized data (e.g., input of entropy encoder 790), bitstream data (e.g., output of entropy encoder 790), or other types of encoded data produced by one of the encoding stages.

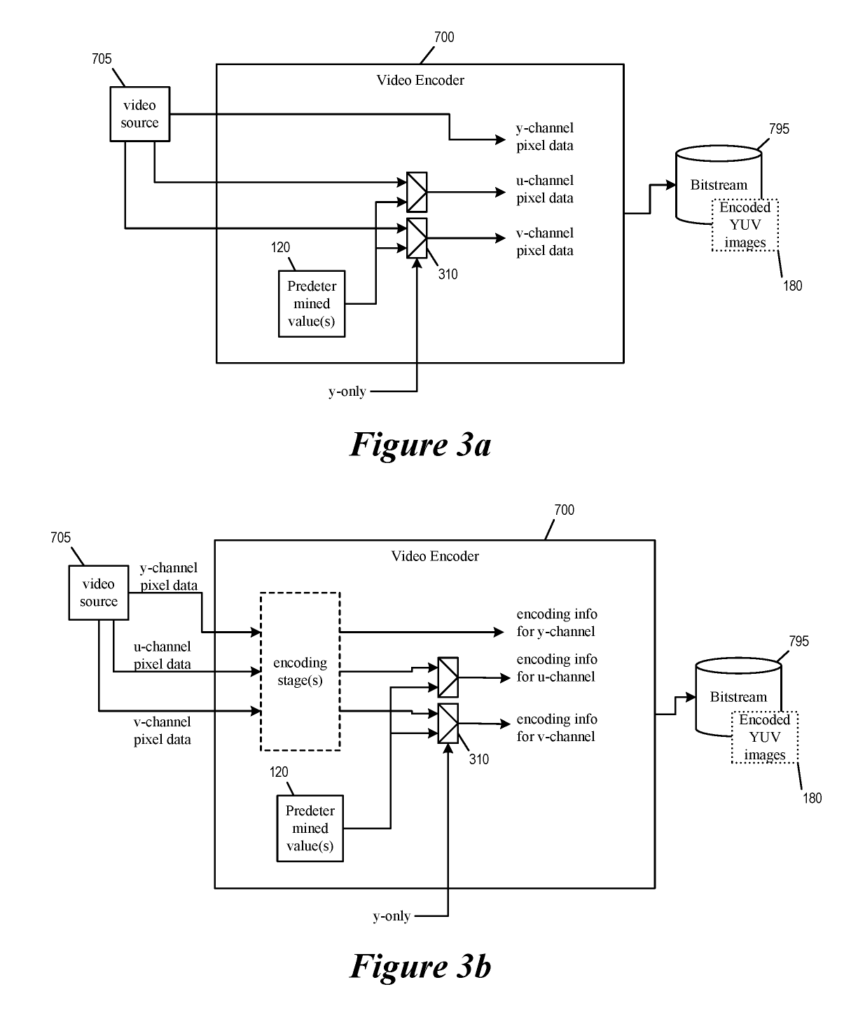

FIGS. 3a-b illustrates the single-channel mode flag being used to determine whether to perform single-channel encoding. FIG. 3a illustrates the single-channel encoding system 100 being configured to use the predetermined value(s) as pixel data for the u/v channel(s) when the single-channel mode flag is asserted. A selection circuit that includes the multiplexer 310 uses the single-channel mode flag to select between pixels from the video source 705 and the predetermined value(s) 120 as pixel data for u/v channel(s) as input to the video encoder 700.

FIG. 3b illustrates the single-channel encoding system 100 being configured to use the predetermined value(s) as encoding information (or intermediate encoded data) for u/v channel(s) when the single-channel mode flag is asserted. A selection circuit that includes the multiplexer 310 uses the single-channel mode flag to select between the outputs of the encoding stage(s) of the video encoder 700 and the predetermined value(s) 120 as encoding information for producing the bitstream 795.

Different embodiments of the of the single-channel encoding system 100 use predetermined value(s) as encoding information for u/v channels at different stages of the video encoder when performing single channel encoding.

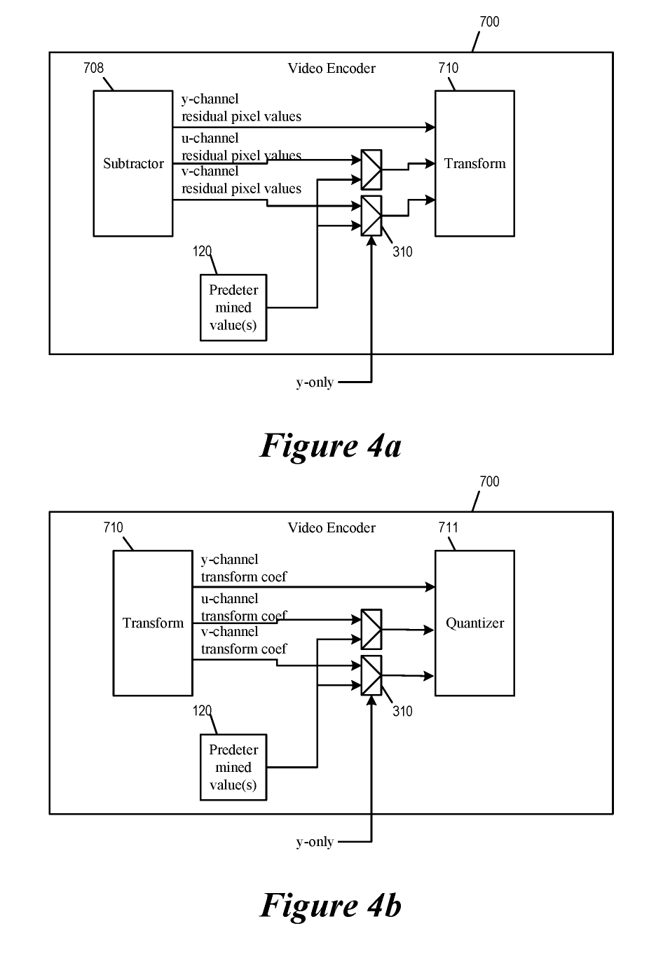

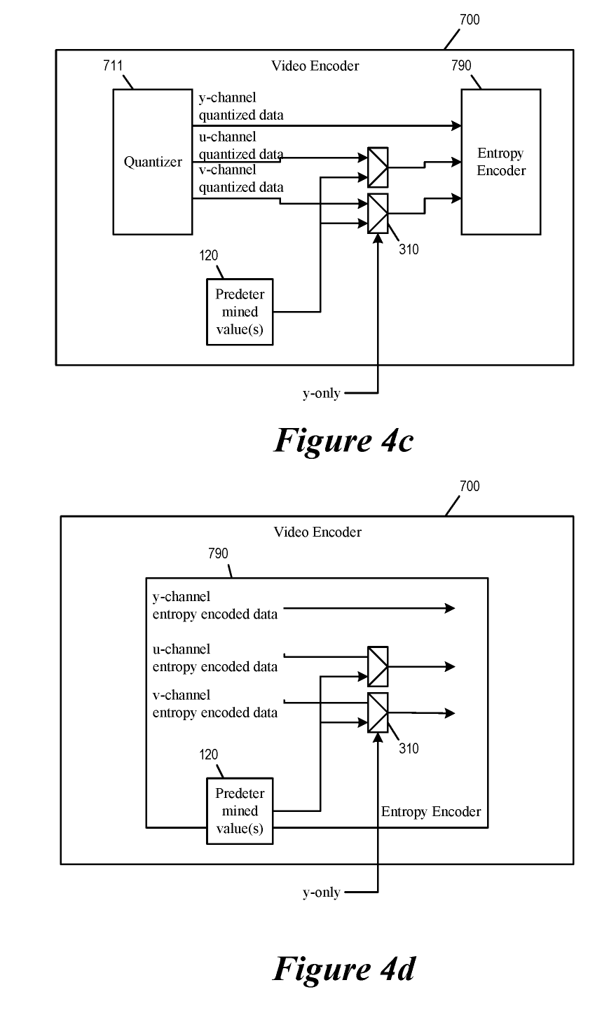

FIG. 4a illustrates the single-channel encoding system 100 being configured to use the predetermined value(s) as inputs to the transform module 710 in the video encoder 100. As illustrated, residual pixel values as computed by the subtractor 708 (e.g., the difference between pixel values from the video source 110 and motion compensation predicted pixel values) for y, u, and v channels are provided as input to the transform module 710. However, the residual pixel values of u-channel and v-channel are replaced by the predetermined values 120 when the multiplexer 310 receives the y-only flag.

FIG. 4b illustrates the single-channel encoding system 100 being configured to use the predetermined value(s) as inputs to the quantizer module 711 in the video encoder 100. As illustrated, transform coefficients as computed by the transform module 710 (e.g., the discrete cosine transform or DCT of the residual pixel data) for y, u, and v channels are provided as input to the quantizer module 711. However, the residual pixel values of u-channel and v-channel are replaced by the predetermined value(s) 120 when the multiplexer 310 receives the y-only flag.

FIG. 4c illustrates the single-channel encoding system 100 being configured use the predetermined value(s) as inputs to the entropy encoder 790 in the video encoder 100. As illustrated, quantized data as computed by the quantizer module 711 (e.g., the quantized versions of the transform coefficients) for y, u, and v channels are provided as input to the entropy encoder 790. However, the quantized data of u-channel and v-channel are replaced by the predetermined value(s) 120 when the multiplexer 310 receives the y-only flag.

FIG. 4d illustrates the single-channel encoding system 100 being configured use the predetermined value(s) as entropy encoded data for the entropy encoder 790 in the video encoder 100. As illustrated, entropy encoded data as computed by the entropy encoder module 790 (e.g., the variable length coded computed according to context adaptive binary arithmetic coding) for y, u, and v channels are to be stored as part of the bitstream 795. However, the entropy encoded data of u-channel and v-channel are replaced by the predetermined value(s) 120 when the multiplexer 310 receives the y-only flag.

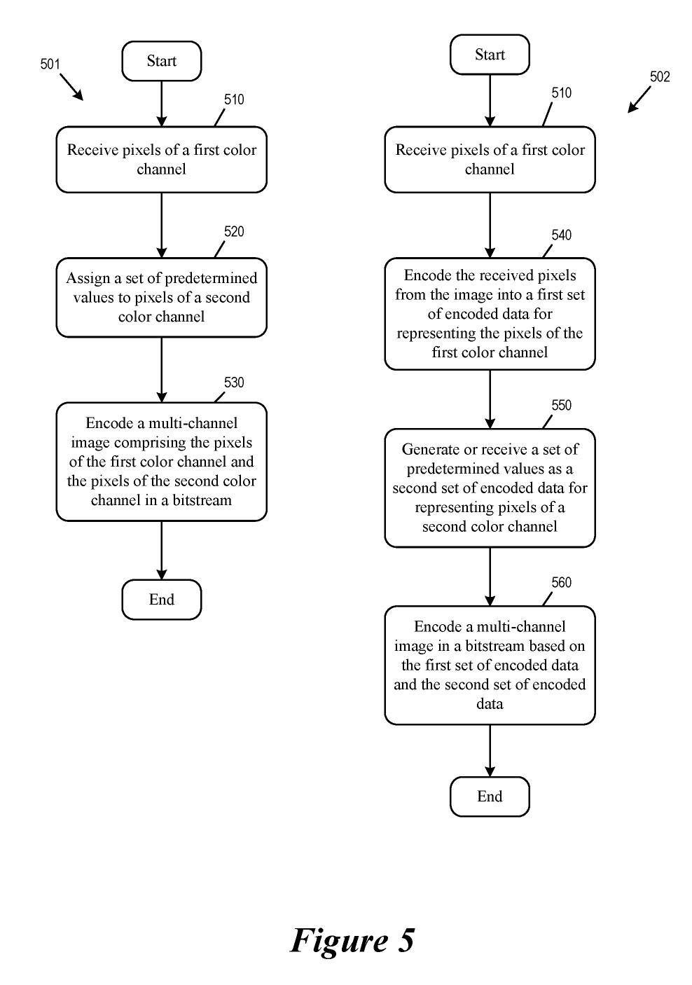

FIG. 5 conceptually illustrates processes 501 and 502 for encoding pixels from a single color channel into a bitstream having one or more encoded multi-channel images. In some embodiments, the single-channel encoding system 100 performs the process 501 or the process 502 when it is configured to perform single-channel encoding. In some embodiments, one or more processing units (e.g., a processor) of a computing device implementing the single-channel encoding system 100 performs the process 600 by executing instructions stored in a computer readable medium. In some embodiments, an electronic apparatus implementing the single-channel encoding system 100 performs the process 600.

The process 501 is a single-channel encoding process that uses predetermined value(s) as pixel values of other channels. The process starts when the single-channel encoding system 100 receives (at step 510) pixels of a first color channel (e.g., y-channel). The pixels can be from a single channel image (e.g., an image with only luminance values). The pixels can also be from a multi-channel image that includes pixels in the first color channel. The pixel can also come from a video source such as the video source 705.

The single-channel encoding system 100 assigns (at step 520) a set of predetermined values to pixels of a second color channel (e.g., u-channel and/or v-channel). The predetermined values are independent of the video source of step 510 and may be internally provided by the single-channel encoding system itself. The pixels of the second color channel therefore may be assigned the same predetermined value. The pixels of the second color channel may also be assigned according to a predetermined sequence or a predefined image.

The single-channel encoding system 100 encodes (at step 530) a multi-channel image that includes pixels of the first color channel and the pixels of the second color channel in a bitstream (the pixels of the second color channel assigned the predetermined value). The encoding process may comply with a known image or video coding standard, and may include operational stages such as transform, quantization, prediction, and entropy encoding. The process 501 then ends.

The process 502 is a single-channel encoding process that uses predetermined value(s) as intermediate encoded data (or encoding information) in the encoding process. The process starts when the single-channel encoding system receives (at step 510) pixels of a first color channel (e.g., y-channel). The pixels can come from a single channel image (e.g., an image with only luminance values). The pixels can also come from a multi-channel image that includes pixels in the first color channel. The pixel can also come from a video source such as the video source 705.

The single-channel encoding system encodes (at step 540) the received pixels of the first channel into a first set of encoded data for representing the pixels of the first color channel. This first set of encoded data may include transform coefficients of y-channel, quantized data of y-channel, or entropy encoded data of y-channel, or other data encoded from the pixels of the y-channel during the encoding process.

The single-channel encoding system generates or receives (at step 550) a set of predetermined values as a second set of encoded data for representing pixels of a second color channel. The set of predetermined values are independent of the source of the pixels received at the step 510 and may be internally generated by the circuitry of the single-channel encoding system without an external source. The set of predetermined values may be used as transform coefficients of u/v-channel(s) (as illustrated in FIG. 4b), quantized data of u/v-channel(s) (as illustrated in FIG. 4c), or other intermediate form of encoded data of the u/v-channels used by the encoding process.

The single-channel encoding system encodes (at step 560) a multi-channel image in a bitstream based on the first set of encoded data and the second set of encoded data. The process 502 then ends.

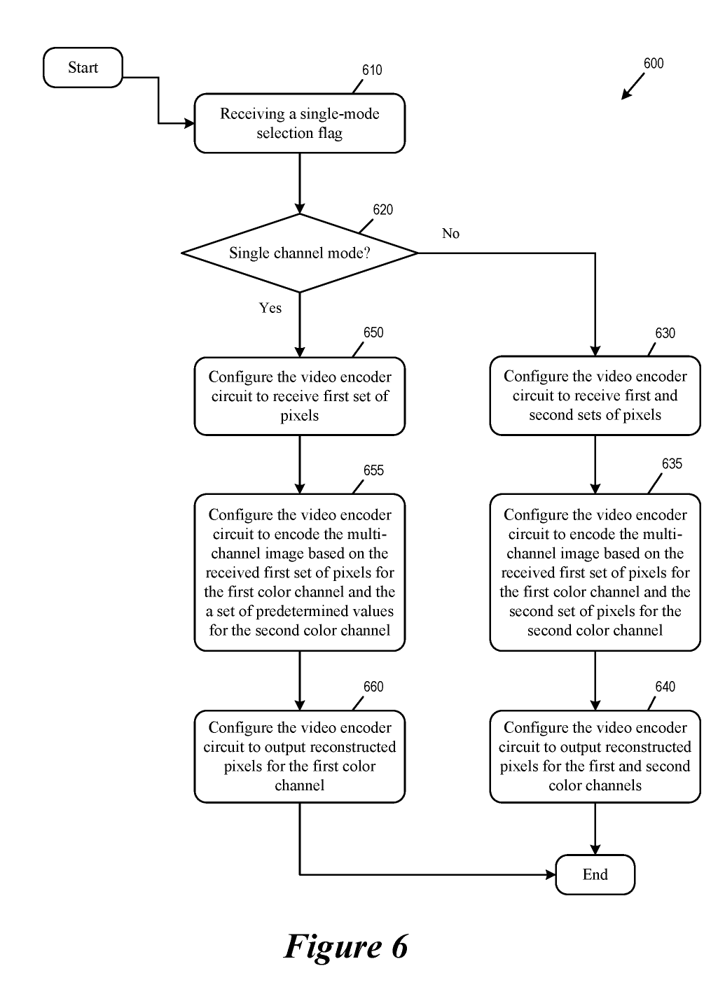

FIG. 6 conceptually illustrates a process 600 that uses a single-channel mode flag to configure the video encoder 700 of the single-channel encoding system 100 to perform single-channel encoding for a first channel or multi-channel encoding for at least the first channel and a second channel. In some embodiments, the single-channel encoding system 100 configures the video encoder 700 by controlling a set of selection circuits (including multiplexers 310 and 315).

In some embodiments, one or more processing units (e.g., a processor) of a computing device implementing the single-channel encoding system 100 performs the process 600 by executing instructions stored in a computer readable medium. In some embodiments, an electronic apparatus implementing the single-channel encoding system 100 performs the process 600.

The process 600 starts when the single-channel encoding system 100 receives (at step 610) a single-channel mode flag. The single-channel encoding system 100 then determines (at step 620) whether to perform either single-channel encoding (y-channel only) or multi-channel encoding (y, u, v channels). The single-channel encoding system 100 may make this determination by examining the single-channel mode flag (e.g., the y-only flag). If the single-channel mode flag is asserted to indicate single-channel encoding, the process proceeds to 650. If the single-channel mode flag is not asserted, the process proceeds to 630.

At step 630, the single-channel encoding system 100 configures (at 630) the video encoder 700 to receive first and second sets of pixels. The single-channel encoding system 100 also configures (at 635) the video encoder to encode the multi-channel image based on the received first set of pixels for the first color channel and the second set of pixels for the second color channel.

The single-channel encoding system configures (at step 640) the video encoder 700 to output the reconstructed pixels of the first and second color channels. The reconstructed pixels are produced based on the encoded information produced by the video encoder 700 of the single-channel encoding system 100. The process 600 then ends.

At step 650, the single-channel encoding system 100 configures the video encoder 700 to receive the first set of pixels for the first color channel. In some embodiments, the video encoder does not receive the second set of pixels for the second channel when the single-channel encoding mode is selected.

The single-channel encoding system configures (at 655) the video encoder 700 to encode the multi-channel image based on the received first set of pixels for the first color channel and a set of predetermined value(s) for the second color channel.

The single-channel encoding system also configures (at step 660) the video encoder 700 to output the reconstructed pixels of the first color channel. The single-channel encoding system does not output pixels of the second channel reconstructed by the video encoder 700. In some embodiments, the single-channel encoding system 100 outputs predetermined value(s) as pixels for the second channel. In some embodiments, the single-channel encoding system does not output any pixels for the second color channel. The process 600 then ends. In some embodiments, the video encoder performs the process 500 of FIG. 5 when the single-channel encoding system configures the video encoder according to the steps 655 and 660.

FIG. 7 illustrates a video encoder 700 or video encoding apparatus that implements the single-channel encoding system 100.

As illustrated, the video encoder 700 receives input video signal from a video source 705 and encodes the signal into bitstream 795. The video encoder 700 has several components or modules for encoding the video signal 705, including a transform module 710, a quantization module 711, an inverse quantization module 714, an inverse transform module 715, an intra-picture estimation module 720, an intra-picture prediction module 725, a motion compensation module 730, a motion estimation module 735, an in-loop filter 745, a reconstructed picture buffer 750, a MV buffer 765, and a MV prediction module 775, and an entropy encoder 790.

In some embodiments, the modules 710-790 are modules of software instructions being executed by one or more processing units (e.g., a processor) of a computing device or electronic apparatus. In some embodiments, the modules 710-790 are modules of hardware circuits implemented by one or more integrated circuits (ICs) of an electronic apparatus. Though the modules 710-790 are illustrated as being separate modules, some of the modules can be combined into a single module.

The video source 705 provides a raw video signal that presents pixel data of each video frame without compression. A subtractor 708 computes the difference between the raw video pixel data of the video source 705 and the predicted pixel data 713 from motion compensation 730 or intra-picture prediction 725. The transform 710 converts the difference (or the residual pixel data) into transform coefficients (e.g., by performing Discrete Cosine Transform, or DCT). The quantizer 711 quantized the transform coefficients into quantized data (or quantized transform coefficients) 712, which is encoded into the bitstream 795 by the entropy encoder 790.

The inverse quantization module 714 de-quantizes the quantized data (or quantized transform coefficients) 712 to obtain transform coefficients, and the inverse transform module 715 performs inverse transform on the transform coefficients to produce reconstructed pixel data (after adding prediction pixel data 713). In some embodiments, the reconstructed pixel data is temporarily stored in a line buffer (not illustrated) for intra-picture prediction and spatial MV prediction. The reconstructed pixels are filtered by the in-loop filter 745 and stored in the reconstructed picture buffer 750. In some embodiments, the reconstructed picture buffer 750 is a storage external to the video encoder 700 (such as the external storage 170 that receives reconstructed y-channel pixels through the pixel transport 150). In some embodiments, the reconstructed picture buffer 750 is a storage internal to the video encoder 700.

The intra-picture estimation module 720 performs intra-prediction based on the reconstructed pixel data 717 to produce intra prediction data. The intra-prediction data is provided to the entropy encoder 790 to be encoded into bitstream 795. The intra-prediction data is also used by the intra-picture prediction module 725 to produce the predicted pixel data 713.

The motion estimation module 735 performs inter-prediction by producing MVs to reference pixel data of previously decoded frames stored in the reconstructed picture buffer 750. These MVs are provided to the motion compensation module 730 to produce predicted pixel data. These MVs are also necessary for reconstructing video frame at the single-channel decoding system. Instead of encoding the complete actual MVs in the bitstream, the video encoder 700 uses temporal MV prediction to generate predicted MVs, and the difference between the MVs used for motion compensation and the predicted MVs is encoded as residual motion data and stored in the bitstream 795 for the single-channel decoding system.

The video encoder 700 generates the predicted MVs based on reference MVs that were generated for encoding previously video frames, i.e., the motion compensation MVs that were used to perform motion compensation. The video encoder 700 retrieves reference MVs from previous video frames from the MV buffer 765. The video encoder 700 stores the MVs generated for the current video frame in the MV buffer 765 as reference MVs for generating predicted MVs.

The MV prediction module 775 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 795 by the entropy encoder 790.

The entropy encoder 790 encodes various parameters and data into the bitstream 795 by using entropy-coding techniques such as context-adaptive binary arithmetic coding (CABAC) or Huffman encoding. The entropy encoder 790 encodes parameters such as quantized transform data and residual motion data into the bitstream.

The in-loop filter 745 performs filtering or smoothing operations on the reconstructed pixels to reduce the artifacts of coding, particularly at boundaries of pixel blocks. In some embodiments, the filtering operation performed includes sample adaptive offset (SAO). In some embodiment, the filtering operations include adaptive loop filter (ALF).

### Single Channel Decoder

Some embodiments of the disclosure provide an image or video decoding system that can be configured to perform single color channel decoding. The single-channel decoding system is an image or video coding electronic apparatus that includes a video decoder capable of decoding a bitstream having an encoded multi-channel image having at least first and second color channels. The single-channel decoding system also includes a selection circuit capable of identifying a single-channel mode flag based on content of the bitstream.

When the single-channel mode flag indicates a first mode, the selection circuit configures the video decoder to decode the multi-channel image to generate pixels of the first and second color channels and to output the decoded pixels of the first and second color channels. When the single-channel mode flag indicates a second mode, the selection circuit configures the video decoder to decode the multi-channel image to generate pixels of the first channel and to output the decoded pixels of the first color channel. The single-channel decoding system does not decode pixels for the second color channel and does not output the decoded pixels of the second color channel.

In some embodiments, the single-channel decoding system receives a bitstream that includes one or more encoded multi-channel images. The bitstream has a first set of encoded data for a first color channel and a second set of encoded data for a second color channel. The single-channel decoding system discards the second set of encoded data. The single-channel decoding system processes the first set of encoded data to obtain the pixels of the first color channel and outputs the pixels of the first color channel as a single channel image. In some embodiments, the single channel decoding system also generates pixels of the second color channel by assigning a set of predetermined values as the pixels of the second color channel (rather than decoding the second set of encoded data).

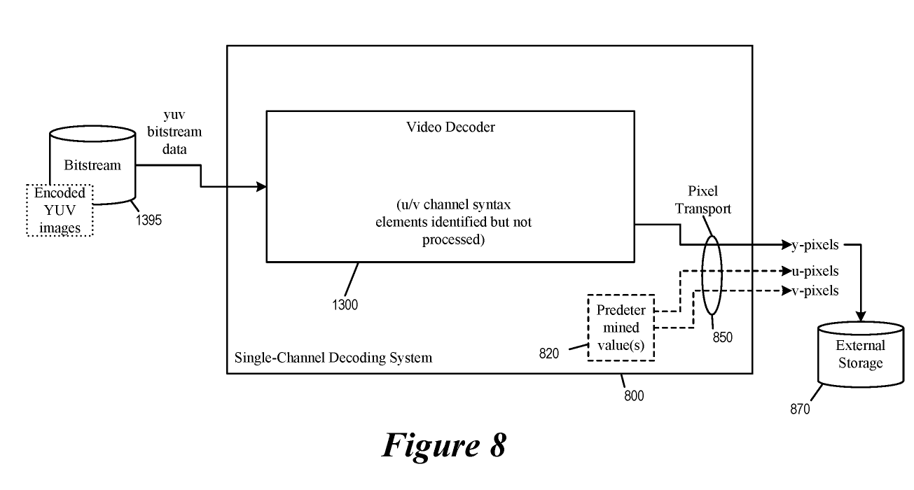

FIG. 8 illustrates a single-channel decoding system 800 that is configured to produces a single color channel image (or video) by decoding a bitstream 1395 having one or more encoded multi-channel images. As illustrated, the single-channel decoding system 800 receives a bitstream 1395, uses a video decoder 1300 to perform image/video decoding techniques (including decompression) to produce pixels in a first color channel (e.g., y-channel). The single-channel decoding system also produces pixels for a second color channel (e.g., u-channel and/or v-channel). The pixels of the second color channel are not derived from the bitstream 1395 but are instead provided by a set of predetermined values 820.

The bitstream 1395 includes a compressed or encoded image or a compressed/encoded sequence of images as a video in a format that conforms to an image-coding or video-coding standard, such as JPEG, MPEG, HEVC, VP9, etc. The image encoded in the bitstream may include encoded data for pixels in multiple color channels, such as y-channel, u-channel, and v-channel. The pixels of the different color channels may be in color formats such as 4:4:4, 4:2:2, or 4:2:0.

The predetermined value(s) 820 may be provided by circuit or storage that is external to the single-channel decoding system 800. The predetermined value(s) 820 may also be provided internally by the single-channel decoding system 800 itself. The predetermined value(s) 820 may also be provided by the internal logic of the video decoder 1300. In other words, the predetermined value(s) are not received from sources external to the single-channel decoding system 800 (external memory, external storage, etc.) For example, the predetermined value(s) 820 may be defined by the circuitry of the single-channel decoding system 800 as part of its hardwired logic or as part of its programming.

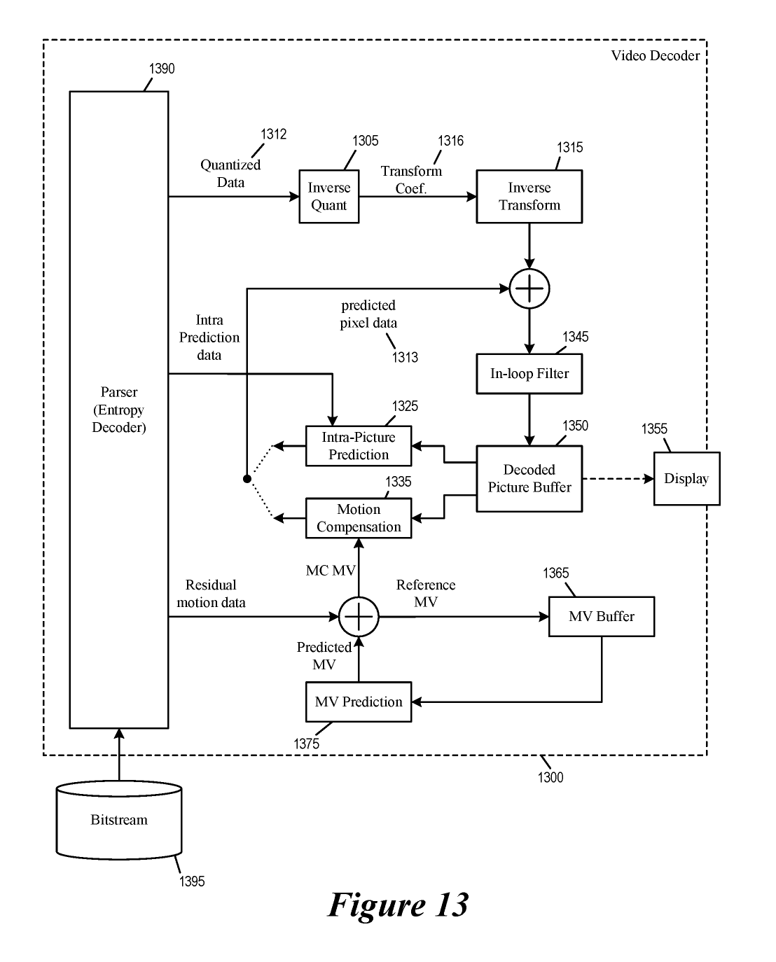

The video decoder 1300 is an image-decoding or a video-decoding circuit that performs image and/or video decoding operations based on the content of the bitstream 1395, which may conform to any image-coding or video-coding standard, such as JPEG, MPEG, HEVC, VP9, etc. The video decoder 1300 includes several modules that are configured to performing various stages of the image/video decoding operations, modules such as an inverse transform module 1315, an inverse quantization module 1305, an entropy decoder module 1390, and various prediction modules (e.g., intra prediction 1325 and motion compensation 1335). FIG. 13 below provides more detailed descriptions of the various modules inside the video decoder 1300.

FIG. 8 shows the single-channel decoding system 800 being configured as a single channel decoder. The video decoder 1300 identifies from the bitstream 1395 syntax elements for y, u, and v channels and then processes only the syntax elements for y-channel. The syntax elements for u and v channels are discarded and not processed further by the video decoder 1300. Consequently, the video decoder 1300 decodes the bitstream 1395 to produce y-channel pixels but not u-channel and v channel pixels. The decoded y-channel pixels are outputted through a pixel transport 850 to an external destination (e.g., an external memory 870 or a display device). The single-channel decoding system may also use the predetermined values 820 to produce pixels for u-channel and/or v-channel to be outputted through the pixel transport 850 as well. In some embodiments, the pixel transport 850 recognizes redundancy (such as repeat) in the pixel values being outputted and performs compression to remove some of the redundancy. In some embodiments, the external destination is initialized with fixed values for u-channel and v-channel pixels, and the pixel transport 850 does not transport any pixel values for the u and v channels.

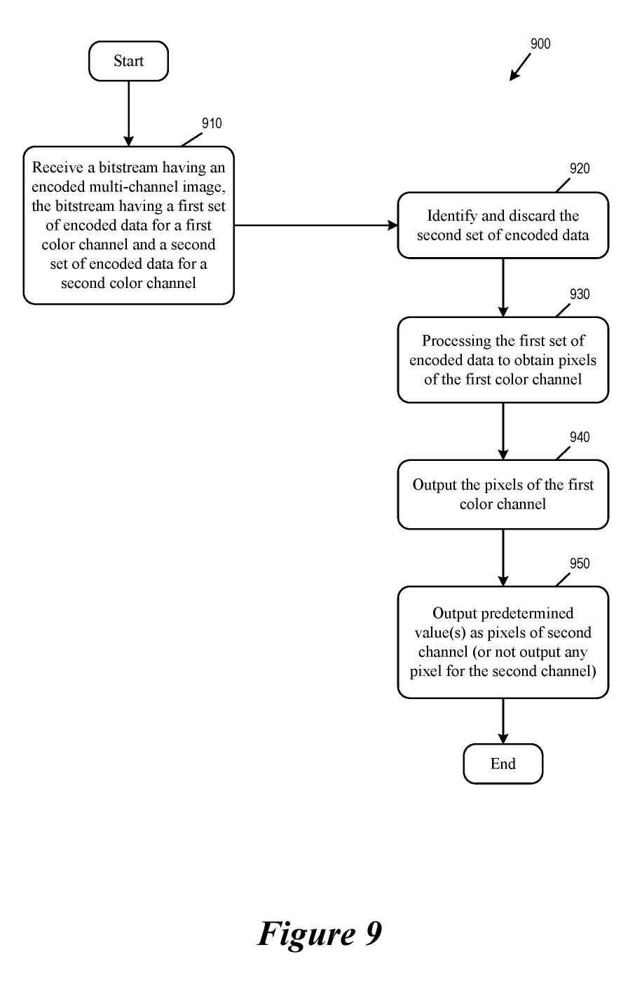

FIG. 9 conceptually illustrates a process 900 for performing single-channel decoding. In some embodiments, one or more processing units (e.g., a processor) of a computing device implementing the single-channel decoding system 800 performs the process 900 by executing instructions stored in a computer readable medium. In some embodiments, an electronic apparatus implementing the single-channel decoding system 800 performs the process 900.

The process 900 starts when the single-channel decoding system 800 receives (at step 910) a bitstream. The bitstream has one or more encoded multi-channel images that are encoded with a first set of encoded data for the first color channel and a second set of encoded data for a second color channel.

The single-channel decoding system identifies (at step 920) and discards the second set of encoded data so that it would not be processed further by the single-channel decoding system (the processing of the second set of encoded data is skipped). The single-channel decoding system processes (at step 930) the first set of encoded data to obtain pixels of the first color channel. The single-channel decoding system also outputs (at step 940) the pixels of the first color channel (e.g., to an external memory). Since the second set of encoded data are discarded and not processed by the single-channel decoding system, the single-channel decoding system does not output pixels derived from the bitstream. In some embodiments, the single-channel decoding system 800 outputs (at step 950) predetermined value(s) as pixels for the second channel. In some embodiments, the single-channel decoding system does not output any pixels for the second channel but instead fill the external memory 870 storing the decoded pixels with fixed values for the second channel. The process 900 then ends.

The single-channel decoding system 800 can be configured to serve as either as a single channel decoder or a multi channel decoder based on a single-channel mode flag. In some embodiments, the bitstream 1395 includes a single-channel mode flag. Such a flag may be a syntax element in a header (slice header, picture header, sequence header, etc.) of the bitstream. In some embodiments, rather than relying on a flag in the bitstream, the single-channel decoding system 800 determines whether to perform single-channel decoding by detecting a particular data pattern in a block of pixels encoded in the bitstream, e.g., a block of pixels having a same particular pixel value.

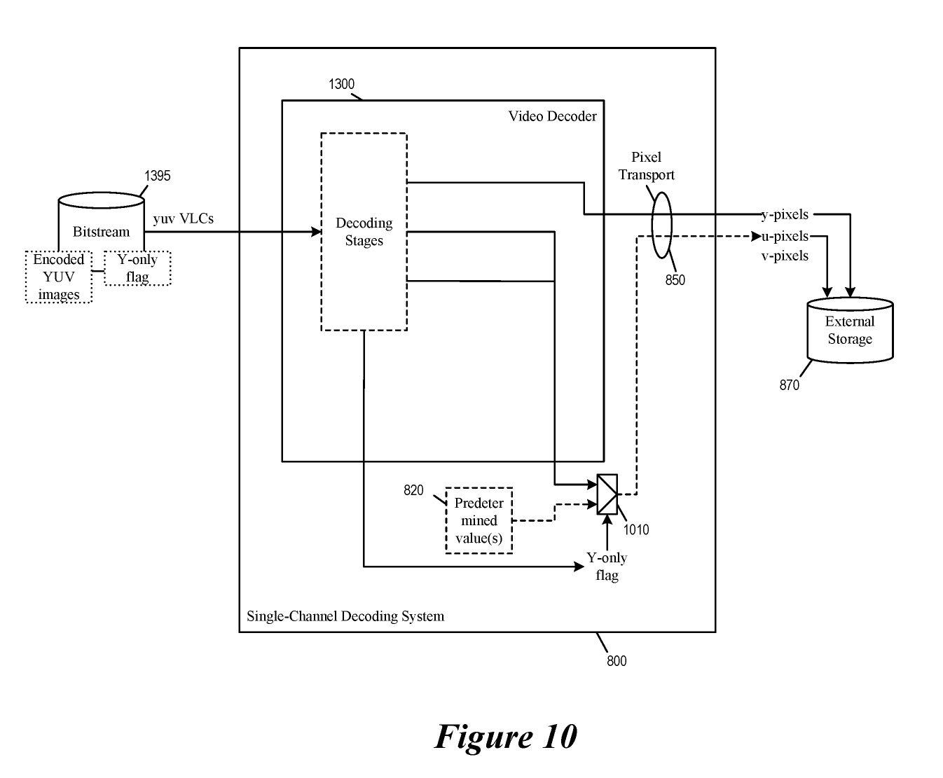

FIG. 10 illustrates the single-channel decoding system 800 being configured to perform single-channel decoding based on a flag embedded in the bitstream. As illustrated, the bitstream 1395 includes a single-channel mode flag (“y-only”) as a syntax element (e.g., as a bit in a slice, picture, or sequence header). When parsing the bitstream, the video decoder 1300 detects the “y-only” flag. When the “y-only” flag is absent, the single-channel decoding system 800 functions as a multi-channel decoder and produces decoded pixels for all color channels (y, u, and v). When the “y-only” flag is present, the single-channel decoding system 800 functions as a single channel decoder. Specifically, the presence of the “y-only” flag causes video decoder 1300 (at e.g., the entropy decoder 1390) to identify and discard syntax elements for u-channel and v-channel.

The presence of the “y-only” flag also causes the single-channel decoding system 800 to output only decoded y-channel pixels through the pixel transport 850 and to forego pixels of u-channel and v-channel. In some embodiments, the presence of the “y-only” flag causes the single-channel decoding system to output predetermined value(s) 820 through the pixel transport. As illustrated, a selector circuit that includes the multiplexer 1010 selects between the predetermined value(s) 820 and output of the decoding stages of the video decoder 1300 based on the “y-only” flag. (The decoding stages of the video decoder 1300 may include the entropy decoder 1390, the inverse quantizer 1305, inverse transform 1315, intra-picture prediction 1325, and/or motion compensation 1335. The output of the decoding stages may be the sum of the output from the motion compensation 1335 and the inverse transform 1315.) The video decoder 1300 may provide the multiplexer 1010 as part of its internal logic circuit. The single-channel decoding system 800 may also provide the multiplexer 1010 as a logic circuit external to the video decoder 1300.

The predetermined value(s) are easily compressible by the pixel transport 850 so the u and v channel pixels would use up minimum bandwidth at the pixel transport 150. In some embodiments, the external storage 870 is initialized with fixed values for u-channel and v-channel pixels, and the pixel transport 850 does not transport any pixel values for the u and v channels.

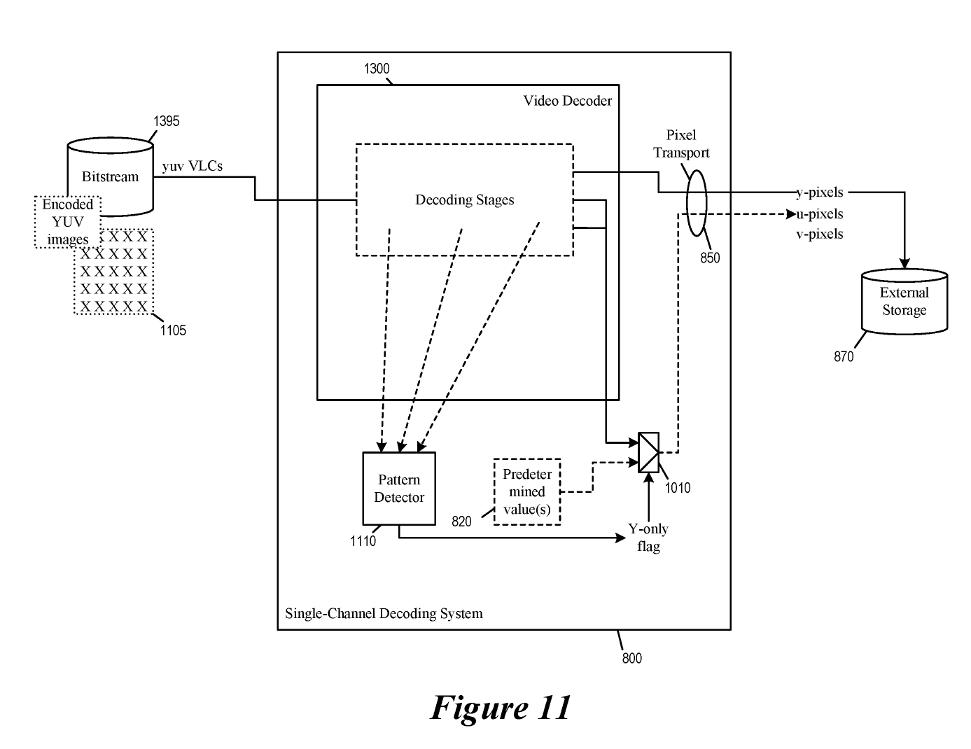

FIG. 11 illustrates the single-channel decoding system 800 being configured to perform single-channel decoding by detecting a particular data pattern. As illustrated, the bitstream 1395 includes one or more encoded images whose pixels may exhibit a particular detectable pattern 1105. The pattern may be detectable after processing by one of the decoding stages in the video decoder 1300. The single-channel decoding system 800 is equipped with a detector 1110 to detect the specified pattern. The pattern may be a block of pixels having the same fixed particular value or some other type of predefined pattern known to the detector 1110. The pattern may be detectable intermediate form of decoded data at different decoding stages of the video decoder 1300. For example, the pattern may be detectable as a particular set of quantized data after the entropy decoder (parser) 1390; or as a particular set of transform coefficients after the inverse quantizer 803; or as a particular set of pixel values after the inverse transform 1315. The video decoder 1300 may provide the pattern detector 1110 as part of its internal logic circuit. The single-channel decoding system 800 may also provide the detector 1110 as a logic circuit external to the video decoder 1300. If the specified pattern is detected, the “y-only” flag may be generated.

The presence of the “y-only” flag also causes the single-channel decoding system 800 to output only decoded y-channel pixels through the pixel transport 850 and to forego pixels of u-channel and v-channel. In some embodiments, the presence of the “y-only” flag causes the single-channel decoding system to output predetermined value(s) 820 through the pixel transport. As illustrated, a selector circuit that includes the multiplexer 1010 selects between the predetermined value(s) 820 and output of the decoding stages of the video decoder 1300 based on the “y-only” flag.

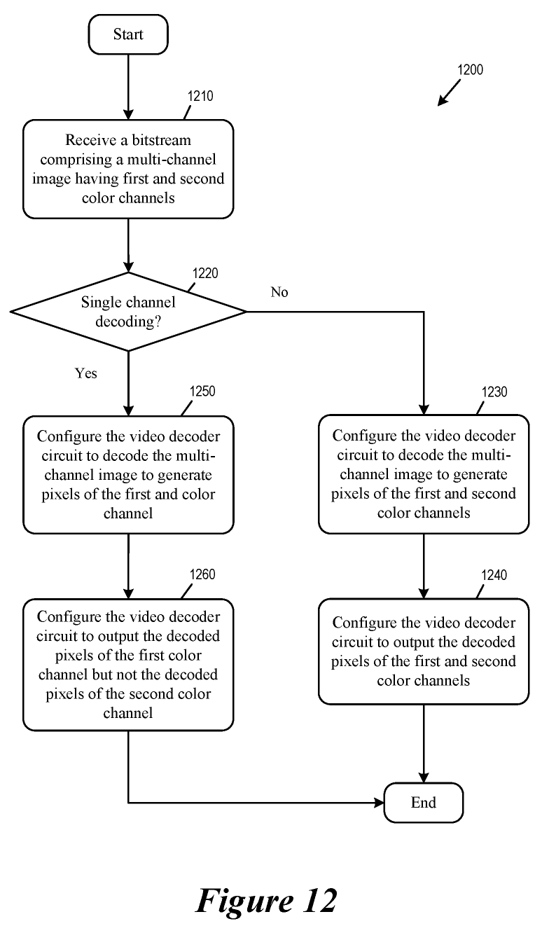

FIG. 12 conceptually illustrates a process 1200 that uses a single-channel mode flag to configure the video decoder 1300 to perform single-channel decoding for a first channel (y-channel) or multi-channel decoding for at least the first channel and a second channel (u/v channel(s)). In some embodiments, one or more processing units (e.g., a processor) of a computing device implementing the single-channel decoding system 800 performs the process 1200 by executing instructions from a computer readable medium. In some embodiments, an electronic apparatus implementing the single-channel decoding system 800 performs the process 1200.

The single-channel decoding system 1200 receives (at step 1210) a bitstream comprising a multi-channel image having first and second color channels. The single-channel decoding system 800 determines (at step 1220) whether to perform single-channel decoding or multi-channel decoding. In some embodiments, the single-channel decoding system makes this determination by parsing the bitstream for a syntax element that corresponds to the single-channel mode flag (described by reference to FIG. 10 above). In some embodiments, the single-channel decoding system makes this determination by detecting for a particular data pattern in the bitstream or an intermediate form of decoded data (described by reference to FIG. 11 above). If single-channel mode is selected, the process proceeds to 1250. Otherwise, the process proceeds to 1230.

At step 1230, the single-channel decoding system 800 configures the video decoder 1300 to decode the multi-channel image to generate pixels of the first and second color channels. The single-channel decoding system 800 also configures (at step 1240) the video decoder to output the decoded pixels of the first and second color channels.

At the step 1250, the single-channel decoding system 1200 configures the video decoder 1300 to decode the multi-channel image to generate pixels of the first color channel. The pixels of the second color channel are not decoded. In some embodiments, the video decoder identifies bitstream syntax elements corresponding to the second color channel (e.g., quantized transform samples of the u/v channels) and discards the identified second color channel syntax elements.

The single-channel decoding system 800 also configures (at step 1260) the video decoder 1300 to output the decoded pixels of the first color channel. The single-channel decoding system does not output pixels of the second channel decoded by the video decoder. In some embodiments, the single-channel decoding system 800 outputs predetermined value(s) as pixels for the second color channel. In some embodiments, the single-channel decoding system does not output any pixels for the second color channel. The process 1200 then ends. In some embodiments, the single-channel decoding system 800 performs the process 900 of FIG. 9 when it configures the video decoder 1300 according to steps 1250 and 1260.

FIG. 13 illustrates a video decoder 1300 or a video decoding apparatus that implements the single-channel decoding system 800. As illustrated, the video decoder 1300 is an image-decoding or video-decoding circuit that receives a bitstream 1395 and decodes the content of the bitstream into pixel data of video frames for display. The video decoder 1300 has several components or modules for decoding the bitstream 1395, including an inverse quantization module 1305, an inverse transform module 1315, an intra-picture prediction module 1325, a motion compensation module 1335, an in-loop filter 1345, a decoded picture buffer 1350, a MV buffer 1365, a MV prediction module 1375, and a bitstream parser 1390.

In some embodiments, the modules 1310-1390 are modules of software instructions being executed by one or more processing units (e.g., a processor) of a computing device. In some embodiments, the modules 1310-1390 are modules of hardware circuits implemented by one or more ICs of an electronic apparatus. Though the modules 1310-1390 are illustrated as being separate modules, some of the modules can be combined into a single module.

The parser 1390 (or entropy decoder) receives the bitstream 1395 and performs initial parsing according to the syntax defined by a video-coding or image-coding standard. The parsed syntax element includes various header elements, flags, as well as quantized data (or quantized transform coefficients) 1312. The parser 1390 parses out the various syntax elements by using entropy-coding techniques such as context-adaptive binary arithmetic coding (CABAC) or Huffman encoding.

The inverse quantization module 1305 de-quantizes the quantized data (or quantized transform coefficients) 1312 to obtain transform coefficients, and the inverse transform module 1315 performs inverse transform on the transform coefficients 1316 to produce decoded pixel data (after adding prediction pixel data 1313 from the intra-prediction module 1325 or the motion compensation module 1335). The decoded pixels data are filtered by the in-loop filter 1345 and stored in the decoded picture buffer 1350. In some embodiments, the decoded picture buffer 1350 is a storage external to the video decoder 1300 (such as the external storage 870 that receives decoded y-channel pixels through the pixel transport 850). In some embodiments, the decoded picture buffer 1350 is a storage internal to the video decoder 1300.

The intra-picture prediction module 1325 receives intra-prediction data from bitstream 1395 and according to which, produces the predicted pixel data 1313 from the decoded pixel data stored in the decoded picture buffer 1350. In some embodiments, the decoded pixel data is also stored in a line buffer (not illustrated) for intra-picture prediction and spatial MV prediction.

In some embodiments, the content of the decoded picture buffer 1350 is used for display. A display device 1355 either retrieves the content of the decoded picture buffer 1350 for display directly, or retrieves the content of the decoded picture buffer to a display buffer. In some embodiments, the display device receives pixel values from the decoded picture buffer 1350 through a pixel transport.

The motion compensation module 1335 produces predicted pixel data 1313 from the decoded pixel data stored in the decoded picture buffer 1350 according to motion compensation MVs (MC MVs). These motion compensation MVs are decoded by adding the residual motion data received from the bitstream 1395 with predicted MVs received from the MV prediction module 1375.

The video decoder 1300 generates the predicted MVs based on reference MVs that were generated for decoding previous video frames, e.g., the motion compensation MVs that were used to perform motion compensation. The video decoder 1300 retrieves the reference MVs of previous video frames from the MV buffer 1365. The video decoder 1300 also stores the motion compensation MVs generated for decoding the current video frame in the MV buffer 1365 as reference MVs for producing predicted MVs.

The in-loop filter 1345 performs filtering or smoothing operations on the decoded pixel data to reduce the artifacts of coding, particularly at boundaries of pixel blocks. In some embodiments, the filtering operation performed includes sample adaptive offset (SAO). In some embodiment, the filtering operations include adaptive loop filter (ALF).

### Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

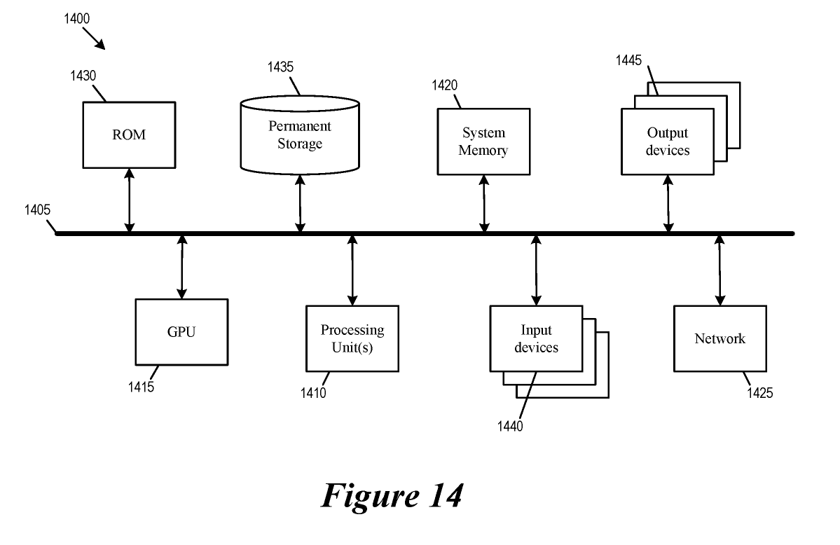

FIG. 14 conceptually illustrates an electronic system 1400 with which some embodiments of the present disclosure are implemented. The electronic system 1400 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1400 includes a bus 1405, processing unit(s) 1410, a graphics-processing unit (GPU) 1415, a system memory 1420, a network 1425, a read-only memory 1430, a permanent storage device 1435, input devices 1440, and output devices 1445.

The bus 1405 collectively represents all system, peripheral, and chipset buses that communicatively connect the numerous internal devices of the electronic system 1400. For instance, the bus 1405 communicatively connects the processing unit(s) 1410 with the GPU 1415, the read-only memory 1430, the system memory 1420, and the permanent storage device 1435.

From these various memory units, the processing unit(s) 1410 retrieves instructions to execute and data to process in order to execute the processes of the present disclosure. The processing unit(s) may be a single processor or a multi-core processor in different embodiments. Some instructions are passed to and executed by the GPU 1415. The GPU 1415 can offload various computations or complement the image processing provided by the processing unit(s) 1410.

The read-only-memory (ROM) 1430 stores static data and instructions that are needed by the processing unit(s) 1410 and other modules of the electronic system. The permanent storage device 1435, on the other hand, is a read-and-write memory device. This device is a non-volatile memory unit that stores instructions and data even when the electronic system 1400 is off. Some embodiments of the present disclosure use a mass-storage device (such as a magnetic or optical disk and its corresponding disk drive) as the permanent storage device 1435.

Other embodiments use a removable storage device (such as a floppy disk, flash memory device, etc., and its corresponding disk drive) as the permanent storage device. Like the permanent storage device 1435, the system memory 1420 is a read-and-write memory device. However, unlike storage device 1435, the system memory 1420 is a volatile read-and-write memory, such a random access memory. The system memory 1420 stores some of the instructions and data that the processor needs at runtime. In some embodiments, processes in accordance with the present disclosure are stored in the system memory 1420, the permanent storage device 1435, and/or the read-only memory 1430. For example, the various memory units include instructions for processing multimedia clips in accordance with some embodiments. From these various memory units, the processing unit(s) 1410 retrieves instructions to execute and data to process in order to execute the processes of some embodiments.

The bus 1405 also connects to the input and output devices 1440 and 1445. The input devices 1440 enable the user to communicate information and select commands to the electronic system. The input devices 1440 include alphanumeric keyboards and pointing devices (also called “cursor control devices”), cameras (e.g., webcams), microphones or similar devices for receiving voice commands, etc. The output devices 1445 display images generated by the electronic system or otherwise output data. The output devices 1445 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 14, bus 1405 also couples electronic system 1400 to a network 1425 through a network adapter (not shown). In this manner, the computer can be a part of a network of computers (such as a local area network (“LAN”), a wide area network (“WAN”), or an Intranet, or a network of networks, such as the Internet. Any or all components of electronic system 1400 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIGS. 5, 6, 9, 12) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method comprising:
receiving a single-channel mode flag for configuring a video encoder that encodes a multi-channel image having at least first and second color channels;
when the single-channel mode flag indicates a first mode:
configuring the video encoder to receive first and second sets of pixels and to encode the multi-channel image based on the received first set of pixels for the first color channel and the received second set of pixels for the second color channel; and
when the single-channel mode flag indicates a second mode:
configuring the video encoder to receive the first set of pixels and to encode the multi-channel image based on the received first set of pixels for the first color channel and a set of predetermined values for the second color channel.

2. The method of claim 1, wherein the first color channel is a luminance channel and the second color channel is a chrominance channel.

3. The method of claim 1, wherein encoding the multi-channel image based on the set of predetermined values for the second color channel comprises assigning a plurality of pixels of the second color channel to a same fixed value.

4. The method of claim 1, wherein the received first and second sets of pixels are pixels of a source image, the first set of pixels belonging to a first color channel of the source image and the second set of pixels belonging to a second color channel of the source image, wherein the set of predetermined values is provided by the video encoder independent of the source image.

5. The method of claim 1, further comprising:
when the single-channel mode flag indicates the first mode:
configuring the video encoder to output reconstruct pixels of the first and second color channels; and
when the single-channel mode flag indicates the second mode:
configuring the video encoder not to output data for the second color channel; or
configuring the video encoder to output a fixed value for the second color channel.

6. The method of claim 1, wherein encoding the multi-channel image based on the set of predetermined values for the second color channel comprises using the set of predetermined values as transform coefficients of the second color channel.

7. The method of claim 1, wherein encoding the multi-channel image based on the set of predetermined values for the second color channel comprises using the set of predetermined values as quantized data of the second color channel.

8. The method of claim 1, wherein encoding the multi-channel image based on the set of predetermined values for the second color channel comprises injecting the set of predetermined values into a bitstream as entropy encoded data.

9. An electronic apparatus comprising:
a video encoder capable of encoding a multi-channel image having at least first and second color channels;
a selection circuit capable of:
receiving a single-channel mode flag;
when the single-channel mode flag indicates a first mode:
configuring the video encoder to receive first and second sets of pixels and to encode the multi-channel image based on the received first set of pixels for the first color channel and the received second set of pixels for the second color channel;
when the single-channel mode flag indicates a second mode:
configuring the video encoder to receive the first set of pixels and to encode the multi-channel image based on the received first set of pixels for the first color channel and a set of predetermined values for the second color channel.

10. The electronic apparatus of claim 9, wherein the first set of pixels and the second set of pixels are pixels of a source image, the first set of pixels belonging to a first color channel of the source image and the second set of pixels belonging to a second color channel of the source image, wherein the set of predetermined values is provided by a logic element in the video encoder independent of the source image.

11. The electronic circuit of claim 9, wherein when the single-channel mode flag indicates the second mode, the video encoder is configured not to output data for the second color channel.

12. The electronic circuit of claim 9, wherein when the single-channel mode flag indicates the second mode, the video encoder is configured to output a fixed value for the second color channel.

13. A method comprising:
receiving a bitstream comprising an encoded multi-channel image having at least first and second color channels;
identifying, based on content of the bitstream, a single-channel mode flag for configuring a video decoder capable of decoding the multi-channel image;
when the single-channel mode flag indicates a first mode:
configuring the video decoder to decode the multi-channel image to generate pixels of the first and second color channels and to output the decoded pixels; and
when the single-channel mode flag indicates a second mode:
configuring the video decoder to decode the multi-channel image to generate pixels of the first color channel and to output the decoded pixels of the first color channel.

14. The method of claim 13, wherein the single-channel mode flag is a syntax element in the bitstream.

15. The method of claim 13, wherein identifying the sing-channel mode flag comprises detecting a block of pixels in the multi-channel image having a set of specified values.

16. The method of claim 13 further comprising identifying encoded data for the second color channel and discarding the identified encoded data for the second color channel.

17. The method of claim 13, wherein pixels for the second color channel are not decoded pixels based on content of the bitstream.

18. An electronic apparatus comprising:
a video decoder capable of decoding a bitstream comprising an encoded multi-channel image having at least first and second color channels;
a selection circuit capable of:
identifying, based on content of the bitstream, a single-channel mode flag for configuring the video decoder capable of decoding the multi-channel image;
when the single-channel mode flag indicates a first mode:
configuring the video decoder to decode the multi-channel image to generate pixels of the first and second color channels and to output the decoded pixels of the first and second color channels;
when the single-channel mode flag indicates a second mode:
configuring the video decoder to decode the multi-channel image to generate pixels of the first color channel and to output the decoded pixels of the first color channel.
